(19) United States
(12) Patent Application Publication
(10) Pub. No.: US 2020/0075271 A1
(43) Pub. Date: Mar. 5, 2020

(54) KEYBOARD DEVICE AND MANUFACTURING METHOD THEREOF

(71) Applicant: Primax Electronics Ltd., Taipei (TW)

(72) Inventors: Ming-Han Wu, Taipei (TW); Che-Wei Yang, Taipei (TW); Yi-Wei Chen, Taipei (TW); Hsien-Tsan Chang, Taipei (TW); Chen-Hsuan Hsu, Taipei (TW)

(21) Appl. No.: 16/193,914

(22) Filed: Nov. 16, 2018

(30) Foreign Application Priority Data
Aug. 31, 2018 (TW) 107130655

(51) Int. Cl. H01H 13/86; H01H 13/85; H01H 13/88

(52) U.S. Cl. CPC H01H 13/86; H01H 13/7065; H01H 13/88; H01H 13/85

(57) ABSTRACT

A keyboard device includes a keyboard base, a flexible protection cover and a protective frame. The flexible protection cover is located over the keyboard base to cover the key structures that are disposed on the keyboard base. The protective frame is disposed on the flexible protection cover. Moreover, plural hollow protrusion structures of the flexible protection cover are partially penetrated through corresponding openings of the protective frame and exposed outside the protective frame. The elastic buffering parts of the flexible protection cover are disposed within corresponding concave structures of the protective frame and covered by the protective frame.

### FIELD OF THE INVENTION

The present invention relates to a structure of an input device, and more particularly to a keyboard device with a flexible protection cover.

### BACKGROUND OF THE INVENTION

In modern societies, electronic products become indispensable parts in human lives. The electronic products are applied in many sectors, including food, clothing, housing, transportation, education and entertainment. Generally, the consumer electronic device is equipped with a keyboard device.

Since the electronic device is essential to the life, the use of the electronic device may generate some problems. For example, because of carelessness, beverage or water may be splashed on the surface of the electronic device. Moreover, the beverage or water may flow into the inner portion of the electronic device through the gaps between the key structures and the housing. Consequently, the electronic device is damaged. Moreover, the dust in the air is possibly introduced into the inner portion of the electronic device through the gaps between the key structures and the housing. The dust may adversely affect the operation of the electronic device.

For preventing water or dust from entering the inner portion of the electronic device, some technologies have been disclosed. For example, an input device with a flexible protection cover is disclosed in Taiwanese Patent No. TWI559176. The flexible protection cover is used for covering the key structures to prevent foreign matters from entering the key structures. However, the flexible protection cover still has some drawbacks. For example, the elastic buffering structures (e.g., coupling parts or sheet-like main body) of the flexible protection cover are exposed to the key operation interface. Since the key structures are frequently depressed, the elastic buffering structures of the flexible protection cover are readily broken or damaged and the keyboard device covered by the flexible protection cover has impaired tactile feel. Moreover, since the material of the flexible protection cover is different from the material of the keycaps, it is difficult to completely attach the flexible protection cover on the surfaces of the keycaps. If the flexible protection cover is not completely attached on the surfaces of the keycaps, the tactile feel of the keyboard device is possibly impaired.

For overcoming the above drawbacks, there is a need of providing a keyboard device with a flexible protection cover. Therefore, the possibility of causing damage of the elastic buffering structure of the flexible protection cover is minimized, and the efficacy of attaching the flexible protection cover on the surfaces of the key structures of the keyboard device is enhanced.

### SUMMARY OF THE INVENTION

The present invention provides a keyboard device with a flexible protection cover. The possibility of causing damage of the elastic buffering structure of the flexible protection cover is minimized. In addition, the efficacy of attaching the flexible protection cover on the surfaces of the key structures of the keyboard device is enhanced.

In accordance with an aspect of the present invention, there is provided a keyboard device. The keyboard device includes a keyboard base, a flexible protection cover and a protective frame. The keyboard base includes plural key structures. The plural key structures include respective keycaps. The flexible protection cover is located over the keyboard base. The flexible protection cover includes a sheet-like main body and plural hollow protrusion structures. The sheet-like main body is disposed on the keyboard base. The plural hollow protrusion structures are formed on the sheet-like main body to cover the corresponding key structures. The plural hollow protrusion structures include respective top parts and respective lateral walls. The top parts and the corresponding lateral walls are connected with each other. The lateral walls include respective elastic buffering parts. The protective frame is disposed on the flexible protection cover. The protective frame has a first surface, a second surface and plural openings. The second surface is opposed to the first surface. The plural openings run through the first surface and the second surface. The plural openings are aligned with the corresponding hollow protrusion structures. Moreover, plural concave structures are formed in the second surface and arranged around peripheries of the corresponding openings. The second surface of the protective frame is connected with the sheet-like main body. The plural hollow protrusion structures are partially penetrated through the corresponding openings and exposed outside the protective frame. The elastic buffering parts are disposed within the corresponding concave structures and covered by the protective frame.

In an embodiment, the flexible protection cover further includes plural covering parts. The plural covering parts are embedded into bottom surfaces of the corresponding top parts and combined with the corresponding keycaps.

In an embodiment, the plural covering parts are made of plastic material, stainless steel, tungsten steel, aluminum or tinplate.

In an embodiment, the plural covering parts and the corresponding keycaps are combined together through plural bonding layers. The plural bonding layers are arranged between the corresponding covering parts and the corresponding keycaps.

In an embodiment, the flexible protection cover is made of rubber or silicone.

In an embodiment, the keyboard base further includes a supporting plate and a membrane circuit board. The membrane circuit board is disposed on the supporting plate.

In an embodiment, each of the plural key structures further includes a connecting element. The connecting element is connected with the corresponding keycap and the supporting plate.

In accordance with another aspect of the present invention, there is provided a manufacturing method of a keyboard device. The manufacturing method includes the following steps. In a step (a), a flexible protection cover is provided. The flexible protection cover includes a sheet-like main body and plural hollow protrusion structures. The plural hollow protrusion structures are formed on the sheet-like main body. The plural hollow protrusion structures include respective top parts and respective lateral walls. The top parts and the corresponding lateral walls are connected with each other. The lateral walls include respective elastic buffering parts. Moreover, plural covering parts are embedded into bottom surfaces of the corresponding top parts. In a step (b), a keyboard base is provided. The keyboard base includes plural key structures. The plural key structures include respective keycaps. In a step (c), the flexible protection cover is placed over keyboard base to have the hollow protrusion structures cover the corresponding key structures, and the covering parts and the corresponding keycaps are combined together. In a step (d), a protective frame is provided. The protective frame has a first surface, a second surface and plural openings. The second surface is opposed to the first surface. The plural openings run through the first surface and the second surface. The plural openings are aligned with the corresponding hollow protrusion structures. Moreover, plural concave structures are formed in the second surface and arranged around peripheries of the corresponding openings. In a step (e), the protective frame is placed over the flexible protection cover. The plural hollow protrusion structures are partially penetrated through the corresponding openings and exposed outside the protective frame. The elastic buffering parts are disposed within the corresponding concave structures and covered by the protective frame.

In the step (c), the plural covering parts and the corresponding keycaps are combined together through plural bonding layers, wherein the plural bonding layers are arranged between the corresponding covering parts and the corresponding keycaps.

Preferably, the step (e) further includes a step of connecting the second surface of the protective frame with the sheet-like main body.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a keyboard device according to an embodiment of the present invention;

FIG. 2 is a schematic cross-sectional view illustrating a portion of the keyboard device according to the embodiment of the present invention; and

FIG. 3 is a flowchart illustrating a manufacturing method of the keyboard device according to the embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

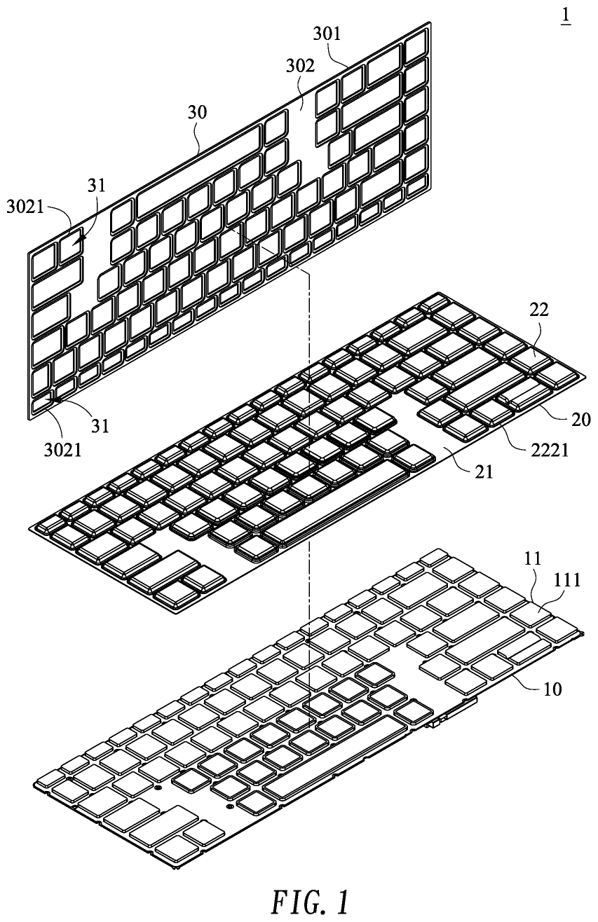

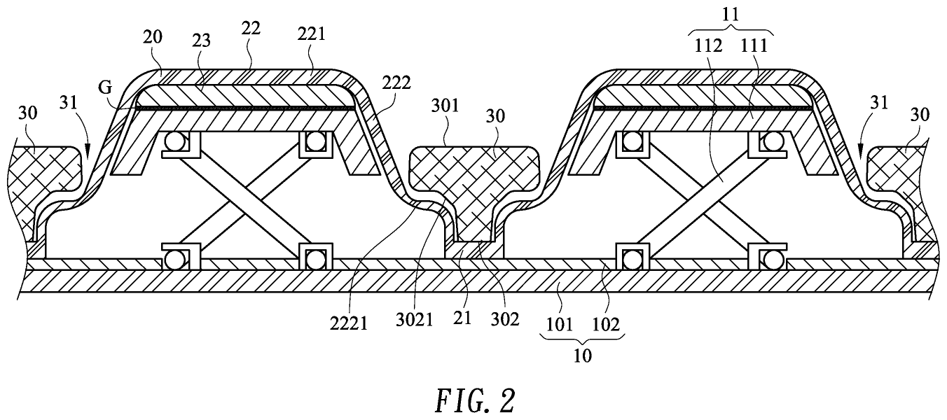

Please refer to FIGS. 1 and 2. FIG. 1 is a schematic exploded view illustrating a keyboard device according to an embodiment of the present invention. FIG. 2 is a schematic cross-sectional view illustrating a portion of the keyboard device according to the embodiment of the present invention.

Please refer to FIG. 1. From bottom to top, a keyboard base 10, a flexible protection cover 20 and a protective frame 30 of the keyboard device 1 are sequentially shown.

The keyboard base 10 comprises plural key structures 11. Each key structure 11 comprises a keycap 111. The flexible protection cover 20 comprises a sheet-like main body 21 and plural hollow protrusion structures 22. The plural hollow protrusion structures 22 are formed on the sheet-like main body 21. The positions and the number of the hollow protrusion structures 22 are determined according to the positions and the number of the key structures 11. Each hollow protrusion structure 22 has a ring-shaped elastic buffering part 2221. Due to the ring-shaped elastic buffering part 2221, the proper deformable distance of the hollow protrusion structure 22 is achieved when the hollow protrusion structure 22 is subjected to curvy deformation. The protective frame 30 has a first surface 301, a second surface 302 and plural openings 31. The second surface 302 is opposed to the first surface 301. The plural openings 31 run through the first surface 301 and the second surface 302. Moreover, the positions and the number of the openings 31 are determined according to the positions and the number of the hollow protrusion structures 22. Moreover, plural concave structures 3021 are formed in the second surface 302 of the protective frame 30 and arranged around the peripheries of the corresponding openings 31. The concave structures 3021 are aligned with the elastic buffering parts 2221 of the corresponding hollow protrusion structure 22. In an embodiment, the flexible protection cover 20 is made of rubber, silicone or any other appropriate elastic material that is permitted to undergo curvy deformation. Consequently, when the user depresses the key structure 11 through the flexible protection cover 20, the touch feel and the tactile feel of depressing the key are enhanced.

Please refer to FIG. 2. As shown in FIG. 2, the keyboard base 10 comprises a supporting plate 101 and a membrane circuit board 102. The membrane circuit board 102 is disposed on the supporting plate 101. The membrane circuit board 102 comprises key switches (not shown) corresponding to the plural key structures 11. When one of the key switches is triggered, a corresponding key signal is generated. The supporting plate 101 is used for supporting the whole keyboard device 1. Each key structure 11 comprises a keycap 111 and a connecting element 112. A first end of the connecting element 112 is pivotally coupled to the keycap 111. A second end of the connecting element 112 is pivotally coupled to the supporting plate 101. The connecting element 112 may drive and guide the keycap 111 to be moved upwardly or downwardly relative to the keyboard base 10. In this embodiment, the connecting element 112 is a scissors-type connecting element. It is noted that the example of the connecting element 112 is not restricted. For example, in another embodiment, the connecting element 112 includes a V-shaped linkage rod, an A-shaped linkage rod or two parallel linkage rods.

The flexible protection cover 20 is located over the keyboard base 10. In addition, the sheet-like main body 21 is attached on the membrane circuit board 102 of the keyboard base 10 through an adhering means. The key structure 11 is covered by the corresponding hollow protrusion structure 22. The hollow protrusion structure 22 comprises a top part 221 and a lateral wall 222, which are connected with each other. The lateral wall 222 is also connected with the sheet-like main body 21. The junction between the lateral wall 222 and the sheet-like main body 21 is a bent structure, i.e., the elastic buffering part 2221. Moreover, the hollow protrusion structure 22 of the flexible protection cover 20 further comprises a covering part 23. The covering part 23 is produced by an insert molding process. Consequently, the covering part 23 is embedded into a bottom surface of the top part 221. For example, the covering part 23 is made of plastic material, stainless steel, tungsten steel, aluminum or tinplate. In this embodiment, a bonding layer G is arranged between the covering part 23 and the keycap 111. For example, the bonding layer G is firstly distributed over the entire or a part of the surface of the covering part 23 or the keycap 111. Consequently, the covering part 23 and the keycap 111 are combined together through the bonding layer G In some other embodiments, the surface of the covering part 23 of the keycap 111 to be coated with the bonding layer G has concave-convex textures (not shown), so that the binding capability of the bonding layer G is increased. For example, the bonding layer G is a glue layer, an adhesive layer or any other appropriate binder layer. Due to the bonding layer G, the hollow protrusion structure 22 of the flexible protection cover 20 can be completely combined with the keycap 111 through the covering part 23. Consequently, when the key structure 11 is depressed through the flexible protection cover 20, the tactile feel of depressing the key structure 11 is enhanced. It is noted that the way of combining the covering part 23 and the keycap 111 through the bonding layer G is not restricted. For example, in some other embodiment, the covering part 23 and the keycap 111 are combined together through a locking means, an engaging means or any other appropriate coupling means.

The protective frame 30 is placed over the flexible protection cover 20. Consequently, the plural hollow protrusion structures 22 are partially penetrated through the corresponding openings 31 and exposed outside the protective frame 30. Then, the second surface 302 of the protective frame 30 is fixed on the sheet-like main body 21 through a hot welding process or a screwing means. Moreover, the elastic buffering parts 2221 are disposed within the corresponding concave structures 3021 and covered by the protective frame 30. Meanwhile, the keyboard device 1 is assembled. When one key structure of the keyboard device 1 is depressed by the user, the elastic buffering part 2221 of the flexible protection cover 20 cannot be touched. Consequently, the possibility of causing the breakage or damage of the elastic buffering part is minimized. Moreover, in case that the color or the pattern of the protective frame 30 is changed, the visual effect of the keyboard device 1 is correspondingly changed.

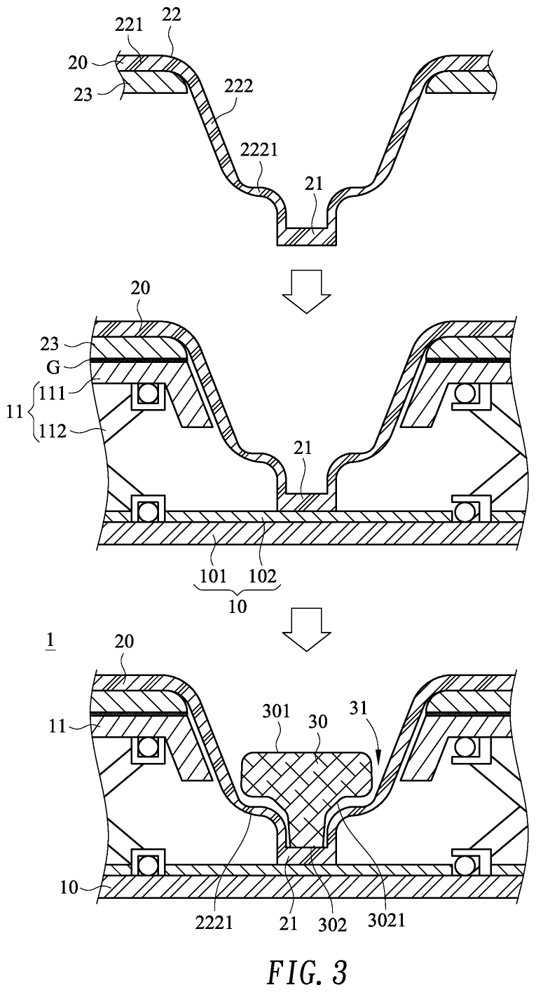

Please refer to FIGS. 1 and 3. FIG. 3 is a flowchart illustrating a manufacturing method of the keyboard device according to the embodiment of the present invention.

Firstly, a flexible protection cover 20 is provided. The flexible protection cover 20 comprises a sheet-like main body 21 and plural hollow protrusion structures 22. The plural hollow protrusion structures 22 are formed on the sheet-like main body 21. The plural hollow protrusion structures 22 comprise respective top parts 221 and respective lateral walls 222. The top parts 221 and the corresponding lateral walls 222 are connected with each other. The lateral walls 222 comprise respective elastic buffering parts 2221. Moreover, plural covering parts 23 are embedded into bottom surfaces of the corresponding top parts 221. After this step, resulting structure is shown in FIG. 3(i).

Then, a keyboard base 10 is provided. The keyboard base 10 comprises plural key structures 11. The plural key structures 11 comprise respective keycaps 111 and respective connecting elements 112. The connecting elements 112 are connected with the corresponding keycaps 111 and the keyboard base 10. Then, the flexible protection cover 20 is placed over the keyboard base 10. Consequently, the key structures 11 are covered by the hollow protrusion structures 22. Moreover, the plural covering parts 23 and the corresponding keycaps 111 are combined together through bonding layers G, which are arranged between the plural covering parts 23 and the corresponding keycaps 111. After this step, resulting structure is shown in FIG. 3(ii).

Then, a protective frame 30 is provided. The protective frame 30 has a first surface 301, a second surface 302 and plural openings 31. The second surface 302 is opposed to the first surface 301. The plural openings 31 run through the first surface 301 and the second surface 302. The plural openings 31 are aligned with the corresponding hollow protrusion structures 22. Moreover, plural concave structures 3021 are formed in the second surface 302 of the protective frame 30 and arranged around peripheries of the corresponding openings 31. Afterwards, the protective frame 30 is placed over the flexible protection cover 20. Consequently, the plural hollow protrusion structures 22 are partially penetrated through the corresponding openings 31 and exposed outside the protective frame 30. Then, the second surface 302 of the protective frame 30 is fixed on the sheet-like main body 21 through a hot welding process or a screwing means. Moreover, the elastic buffering parts 2221 are disposed within the corresponding concave structures 3021 and covered by the protective frame 30. After this step, resulting structure is shown in FIG. 3(iii).

From the above descriptions, the present invention provides a keyboard device. In accordance with the present invention, the elastic buffering parts are covered by the protective cover. Consequently, even if the key structures are frequently depressed, the possibility of causing breakage or damage of the elastic buffering parts is minimized. Moreover, the covering parts are embedded into the hollow protrusion structures of the flexible protection cover. The covering parts and the corresponding keycaps combined together. Consequently, the efficacy of attaching the flexible protection cover on the key structures is enhanced. In other words, the keyboard device of the present invention is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard device, comprising:
a keyboard base comprising plural key structures, wherein the plural key structures comprise respective keycaps;
a flexible protection cover located over the keyboard base, and comprising a sheet-like main body and plural hollow protrusion structures, wherein the sheet-like main body is disposed on the keyboard base, the plural hollow protrusion structures are formed on the sheet-like main body to cover the corresponding key structures, and the plural hollow protrusion structures comprise respective top parts and respective lateral walls, wherein the top parts and the corresponding lateral walls are connected with each other, and the lateral walls comprises respective elastic buffering parts; and
a protective frame disposed on the flexible protection cover, and having a first surface, a second surface and plural openings, wherein the second surface is opposed to the first surface, the plural openings run through the first surface and the second surface, the plural openings are aligned with the corresponding hollow protrusion structures, and plural concave structures are formed in the second surface and arranged around peripheries of the corresponding openings,
wherein the second surface of the protective frame is connected with the sheet-like main body, the plural hollow protrusion structures are partially penetrated through the corresponding openings and exposed outside the protective frame, and the elastic buffering parts are disposed within the corresponding concave structures and covered by the protective frame.

2. The keyboard device according to claim 1, wherein the flexible protection cover further comprises plural covering parts, wherein the plural covering parts are embedded into bottom surfaces of the corresponding top parts and combined with the corresponding keycaps.

3. The keyboard device according to claim 2, wherein the plural covering parts are made of plastic material, stainless steel, tungsten steel, aluminum or tinplate.

4. The keyboard device according to claim 2, wherein the plural covering parts and the corresponding keycaps are combined together through plural bonding layers, wherein the plural bonding layers are arranged between the corresponding covering parts and the corresponding keycaps.

5. The keyboard device according to claim 1, wherein the flexible protection cover is made of rubber or silicone.

6. The keyboard device according to claim 1, wherein the keyboard base further comprises a supporting plate and a membrane circuit board, wherein the membrane circuit board is disposed on the supporting plate.

7. The keyboard device according to claim 6, wherein each of the plural key structures further comprises a connecting element, and the connecting element is connected with the corresponding keycap and the supporting plate.

8. A manufacturing method of a keyboard device, the manufacturing method comprising steps of:
(a) providing a flexible protection cover, wherein the flexible protection cover comprises a sheet-like main body and plural hollow protrusion structures, the plural hollow protrusion structures are formed on the sheet-like main body, and the plural hollow protrusion structures comprise respective top parts and respective lateral walls, wherein the top parts and the corresponding lateral walls are connected with each other, the lateral walls comprise respective elastic buffering parts, and plural covering parts are embedded into bottom surfaces of the corresponding top parts;
(b) providing a keyboard base, wherein the keyboard base comprises plural key structures, and the plural key structures comprise respective keycaps;
(c) placing the flexible protection cover over the keyboard base to have the hollow protrusion structures cover the corresponding key structures, and allowing the covering parts and the corresponding keycaps to be combined together;
(d) providing a protective frame having a first surface, a second surface and plural openings, wherein the second surface is opposed to the first surface, the plural openings run through the first surface and the second surface, the plural openings are aligned with the corresponding hollow protrusion structures, and plural concave structures are formed in the second surface and arranged around peripheries of the corresponding openings; and
(e) placing the protective frame over the flexible protection cover, wherein the plural hollow protrusion structures are partially penetrated through the corresponding openings and exposed outside the protective frame, and the elastic buffering parts are disposed within the corresponding concave structures and covered by the protective frame.

9. The manufacturing method according to claim 8, wherein in the step (c), the plural covering parts and the corresponding keycaps are combined together through plural bonding layers, wherein the plural bonding layers are arranged between the corresponding covering parts and the corresponding keycaps.

10. The manufacturing method according to claim 8, wherein the step (e) further comprises a step of connecting the second surface of the protective frame with the sheet-like main body.
